(19) United States
(12) Patent Application Publication
(10) Pub. No.: US 2024/0322323 A1
(43) Pub. Date: Sep. 26, 2024

(54) POWER STORAGE DEVICE

(71) Applicants: TOYOTA JIDOSHA KABUSHIKI KAISHA, Toyota-shi (JP); SUBARU CORPORATION, Tokyo (JP)

(72) Inventors: Shigeyuki Inoue, Toyota-shi (JP); Tatsuma Yahara, Seto-shi (JP); Yasuhiro Sekiya, Tokyo (JP)

(73) Assignees: TOYOTA JIDOSHA KABUSHIKI KAISHA, Toyota-shi (JP); SUBARU CORPORATION, Tokyo (JP)

(21) Appl. No.: 18/433,892

(22) Filed: Feb. 6, 2024

(30) Foreign Application Priority Data
Mar. 24, 2023 (JP) 2023-048148

(51) Int. Cl. H01M 50/24; H01M 10/613; H01M 50/204

(52) U.S. Cl. CPC H01M 50/24; H01M 10/613; H01M 50/204

(57) ABSTRACT

A power storage device includes: a power storage module; an accommodating case that accommodates the power storage module; a cooler that cools the power storage module via the accommodating case; a gap filler being disposed in part of a gap between the power storage module and the accommodating case; and an adhesive part that bonds the gap filler to the accommodating case. The accommodating case includes a cooling area cooled by the cooler. The power storage module and the gap filler are arranged in the cooling area. The gap filler includes an opposite surface that faces the cooling area. The adhesive part is arranged at a periphery of the opposite surface so as to seal a gap between the opposite surface and the cooling area.

### CROSS-REFERENCE TO RELATED APPLICATION

This application claims priority to Japanese Patent Application No. 2023-048148 filed on Mar. 24, 2023 incorporated herein by reference in its entirety.

### BACKGROUND

### 1. Technical Field

The present disclosure relates to a power storage device mounted in a vehicle.

### 2. Description of Related Art

As a power storage device of the related art, Japanese Unexamined Patent Application Publication No. 2020-181632 discloses a technique that cools power storage stacks from the lower surface thereof.

### SUMMARY

In a power storage device that accommodates a plurality of power storage stacks as a power storage module in an accommodating case, the number of power storage stacks disposed in the same accommodating case might be adjusted depending on the type of a vehicle or the necessary traveling distance. For example, when the number of power storage stacks accommodated is reduced, a space in which no power storage stacks are disposed is generated. In this case, it is conceivable to arrange a gap filler in an area in which no power storage stacks are disposed.

However, the gap filler does not generate heat by power charge and discharge, or the like, which is different from the power storage stacks. Hence, the area in which the gap filler is disposed has a lower temperature than that in the area in which the power storage stacks are disposed; therefore, dew condensation is likely to be generated. When dew condensation is generated, dew condensation water adheres to the high voltage part in the accommodating case, which might cause problems.

The present disclosure has been made in light of the above problems, and an object of the present disclosure is to provide a power storage device in which a gap filler is disposed, the power storage device capable of reducing problems caused by dew condensation water.

A power storage device based on the present disclosure includes: a power storage module; an accommodating case that accommodates the power storage module; a cooler that cools the power storage module via the accommodating case; a gap filler being disposed in part of a gap between the power storage module and the accommodating case; and an adhesive part that bonds the gap filler to the accommodating case. The accommodating case includes a cooling area cooled by the cooler. The power storage module and the gap filler are arranged in the cooling area. The gap filler includes an opposite surface that faces the cooling area. The adhesive part is arranged at a periphery of the opposite surface so as to seal a gap between the opposite surface and the cooling area.

According to the above configuration, the adhesive part is arranged at the periphery of the opposite surface so as to seal the gap between the opposite surface of the gap filler and the cooling area and thereby to keep the dew condensation water generated in the gap inside the adhesive part. Accordingly, it is possible to prevent the dew condensation water from leaking to the outside of the adhesive part, and to prevent the dew condensation water from adhering to the high voltage part inside the accommodating case. Accordingly, it is possible to reduce problems caused by the dew condensation water.

In the power storage device based on the present disclosure, the cooling area is arranged in a bottom part of the accommodating case. The bottom part may be disposed to partially contact the opposite surface within an area surrounded by the adhesive part.

According to the above configuration, by bringing the bottom part configuring the cooling area to partially adhere to the opposite surface of the gap filler, it is possible to reduce an area where dew condensation is generated.

According to the above configuration, the accommodating case includes an upper case and a lower case, and the gap filler includes an upper surface and a lower surface. The opposite surface may be configured by the lower surface. The upper surface may be provided with a protrusion extending in a direction intersecting the height direction and protruding toward the upper case. A top part of the protrusion may be located upward of the power storage module.

According to the above configuration, when a load is applied downward to the upper case, the upper case can be supported by the protrusion of the gap filler and deformation of the upper case can be reduced. In addition, the top part of the protrusion is located upward of the power storage module; therefore, when the load is input as described above, it is possible to prevent the high voltage part included in the power storage module and the upper case from contacting each other. Accordingly, it is possible to protect the power storage module.

In the power storage device based on the present disclosure, the power storage module may include a plurality of power storage stacks arranged side by side in a first direction orthogonal to the height direction. The gap filler may be arranged adjacent to the power storage module side by side in the first direction. A plurality of the protrusions may be arranged side by side in the first direction and extend in a second direction orthogonal to the height direction and the first direction.

According to the above configuration, since the protrusions are provided, it is possible to further reduce deformation of the upper case by the protrusions when the load is input downward from the upper case side. In addition, the protrusions extend in the second direction and are arranged side by side in the first direction and thereby to reduce deformation of the upper case over a wide range.

According to the present disclosure, in the power storage device in which the gap filler is disposed, it is possible to provide the power storage device capable of reducing problems caused by dew condensation water.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view showing a vehicle according to Embodiment 1;

FIG. 2 is a plan view of a power storage device according to Embodiment 1, in a state in which an upper case of an accommodating case is removed;

FIG. 3 is a schematic sectional view of the power storage device according to Embodiment 1;

FIG. 4 is an enlarged view showing a structure around a gap filler in the power storage device according to Embodiment 1; and

FIG. 5 is a schematic sectional view of a power storage device according to Embodiment 2.

### DETAILED DESCRIPTION OF EMBODIMENTS

Hereinafter, embodiments of the present disclosure will be described in detail with reference to the drawings. In the embodiments described below, the same or common parts will be denoted by the same reference numerals in the drawings, and the description thereof will not be repeated.

### Embodiment 1

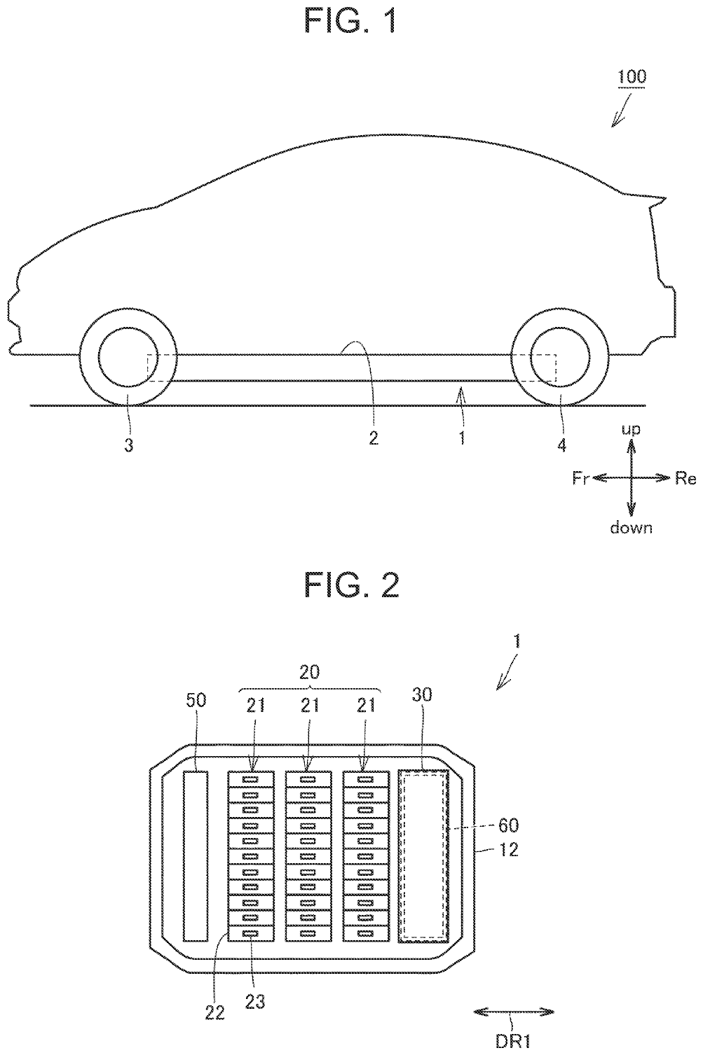

FIG. 1 is a schematic view showing a vehicle according to Embodiment 1. With reference to FIG. 1, a vehicle 100 according to Embodiment 1 will be described.

The vehicle 100 according to Embodiment 1 is a hybrid electric vehicle that can travel using power of at least one of a motor and an engine, or an electrified vehicle that travels with driving force obtained from electric energy.

The vehicle 100 includes: a power storage device 1; a floor panel 2; front wheels 3, and rear wheels 4. The power storage device 1 is mounted below the floor panel 2, for example.

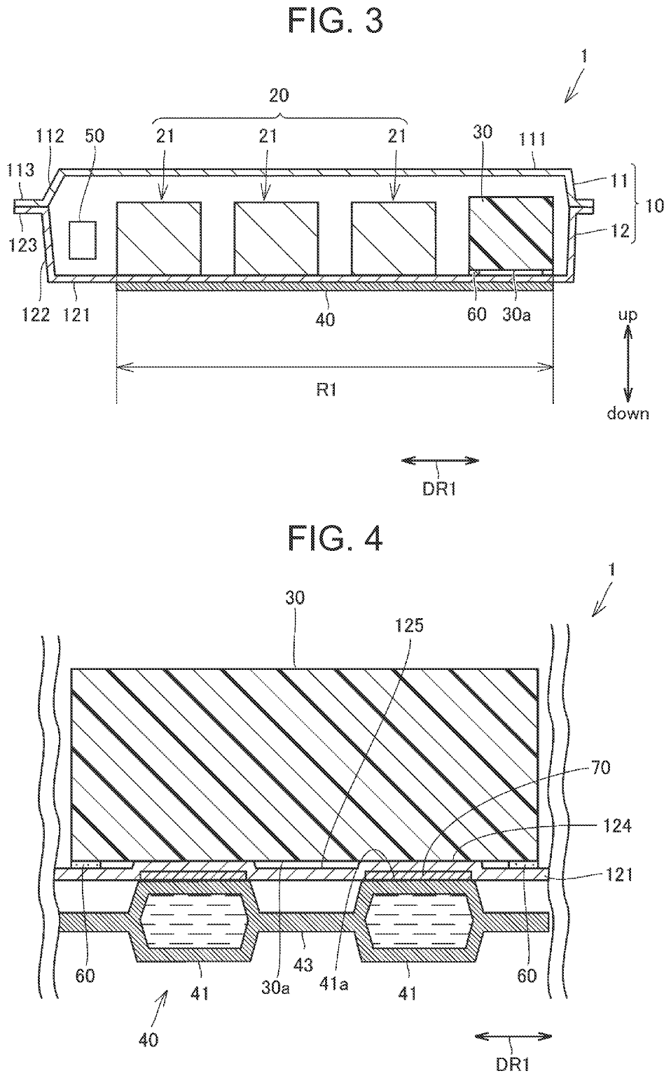

FIG. 2 is a plan view of the power storage device according to Embodiment 1 in a state in which an upper case of an accommodating case is removed. FIG. 3 is a schematic sectional view of the power storage device according to Embodiment 1. With reference to FIGS. 2, 3, the power storage device 1 according to Embodiment 1 will be described.

The power storage device 1 includes an accommodating case 10, power storage modules 20, a gap filler 30, a cooler 40, electronics 50, and an adhesive part 60.

The accommodating case 10 accommodates a plurality of power storage modules 20, the gap filler 30, and the electronics 50 inside. The accommodating case 10 has a cooling area R1 cooled by the cooler 40 described later. The cooling area R1 is arranged in a bottom part 121 described later.

The accommodating case 10 includes an upper case 11 and a lower case 12. The upper case 11 configures the upper part of the accommodating case 10.

The upper case 11 has a substantially box-like shape that opens downward. The upper case 11 includes: a ceiling part 111; a peripheral wall 112; and a flange part 113. The peripheral wall 112 is provided so as to extend from the periphery of the ceiling part 111. The flange part 113 is provided so as to be bent outward from the lower end of the peripheral wall 112.

The lower case 12 has a substantially box-like shape that opens upward. The lower case 12 includes: a bottom part 121, a peripheral wall 122, and a flange part 123. The bottom part 121 is provided so as to face the ceiling part 111. The peripheral wall 122 is provided so as to extend upward from the periphery of the bottom part 121. The flange part 123 is provided so as to be bent outward from the upper end of the peripheral wall 122.

In a state in which the lower surface of the flange part 113 is placed on the upper surface of the flange part 123, the flange part 113 and the flange part 123 are fastened together by a plurality of fastening members. Accordingly, the upper case 11 and the lower case 12 are joined together. 15

The power storage module 20 includes: a plurality of power storage stacks 21. In the embodiment, it is exemplified that each power storage module 20 includes three power storage stacks 21; however, the number of power storage stacks 21 is not limited to three. As long as the gap filler 30 can be disposed inside the accommodating case 10, the number of power storage stacks 21 may be singular, two, or four or more. That is, it is sufficient that the power storage module 20 includes one or more power storage stacks 21.

Each power storage stack 21 includes a plurality of power storage cells 22 arranged side by side in a predetermined arrangement direction. The power storage stack 21 includes a high voltage part. The high voltage part is each of the power storage cells, a bus bar that connects the plurality of power storage cells 22, or a connector, etc. The arrangement direction is, for example, parallel to the width direction of the vehicle in a state in which the power storage device 1 is mounted in the vehicle. The plurality of power storage cells 22 is each provided with an exhaust part 23 that is capable of exhausting gas from the inside to the outside.

The power storage cell 22 is, for example, a secondary battery, such as a nickel-metal hydride battery or a lithium-ion battery. The power storage cell 22 has a square shape, for example. The secondary battery may use a liquid electrolyte or a solid electrolyte.

The plurality of power storage stacks 21 is arranged side by side with intervals in a first direction (DR 1 direction) orthogonal to the above-mentioned arrangement direction. In the mounted state, the first direction is parallel to the front-rear direction of the vehicle, for example.

The plurality of power storage stacks 21 is arranged in thermal contact with the inner surface of the bottom part 121 of the accommodating case 10.

The plurality of power storage stacks 21 and the gap filler 30 are arranged side by side in the first direction. The gap filler 30 is placed farthest from the electronics 50, which will be described later, and is located farthest on one side in the first direction. Note that one side in the first direction is, for example, the rear side of the vehicle in the above-mentioned mounted state.

As the gap filler 30, a resin member such as foamed resin may be used. The gap filler 30 may be made of a material with low thermal conductivity. Accordingly, even when the cooling is performed by the cooler 40 via the cooling area R1, it is possible to reduce generation of dew condensation around the gap filler 30.

The gap filler 30 has a substantially rectangular parallelepiped shape. The gap filler 30 has substantially the same shape as that of the power storage stack 21. The gap filler 30 includes an opposite surface 30a facing the cooling area R1. The opposite surface 30a is configured by the lower surface of the gap filler 30.

The cooler 40 cools the power storage module 20 via the accommodating case 10. The cooler 40 is disposed below the accommodating case 10. The cooler 40 is disposed in thermal contact with the outer surface of the bottom part 121 of the accommodating case 10, for example.

The electronics 50 controls the power storage module 20. The electronics 50 is a cell ECU, for example. The electronics 50 is located on the opposite side to the location of the gap filler 30, in the first direction. That is, one or more power storage stacks 21 are placed between the electronics 50 and the gap filler 30.

The adhesive part 60 fixes the gap filler 30 to the accommodating case 10. Specifically, the adhesive part 60 fixes the gap filler 30 to the bottom part 121. The adhesive part 60 is arranged at the periphery of the opposite surface 30a of the gap filler 30 so as to seal a gap between the opposite surface 30a and the cooling area R1 (more specifically, the bottom part 121). As the adhesive part 60, a waterproof adhesive or a double-sided tape can be adopted.

FIG. 4 is an enlarged view showing the structure around the gap filler in the power storage device according to Embodiment 1.

As shown in FIG. 4, the cooler 40 includes, for example, a plurality of flow passages 41 through which a coolant flows, and connection parts 43 that connect the flow passages 41 adjacent to each other. The plurality of flow passages 41 is arranged side by side in the first direction. Each flow passage 41 has an upper surface 41a. The upper surface 41a is located upward of the connection part 43.

The cooler 40 is fixed to the bottom part 121 of the accommodating case 10 by an adhesive layer 70 having thermal conductivity. The bottom part 121 includes a plurality of ridge portions 124 and a plurality of flat portions 125. Portions of the bottom part 121 to which the adhesive layer 70 is disposed are formed into the plurality of ridge portions 124 such that the inner surface of the bottom part 121 rises toward the gap filler 30 side (upward). Two ridge portions 124 are arranged side by side with intervals in the first direction. The gap filler 30 is placed on these two ridge portions 124. Accordingly, a gap is formed between portions of the bottom part 121 having no ridge portions 124 (that is, the flat portions 125) and the gap filler 30. Note that the number of ridge portions 124 is not limited to two, and may be singular or three or more.

The ridge portions 124 on which the cooler 40 is placed are provided within an area surrounded by the adhesive part 60; therefore, the bottom part 121 of the accommodating case 10 partially contacts the opposite surface 30a within this area. In this way, by bringing the bottom part configuring the cooling area R1 to partially adhere to the opposite surface 30a, it is possible to reduce an area where dew condensation is generated.

Furthermore, in the present embodiment, the adhesive part 60 is arranged at the periphery of the opposite surface 30a so as to seal the gap between the opposite surface 30a of the gap filler 30 and the cooling area R1, and thereby retaining dew condensation water generated in the gap between the opposite surface 30a and the cooling area R1 inside the adhesive part 60. Accordingly, the dew condensation water can be prevented from leaking to the outside of the adhesive part 60, and the dew condensation water can be prevented from adhering to the electronics 50 or the high voltage part included in the power storage module 20 within the accommodating case 10. As a result, problems caused by the dew condensation water can be reduced.

### Embodiment 2

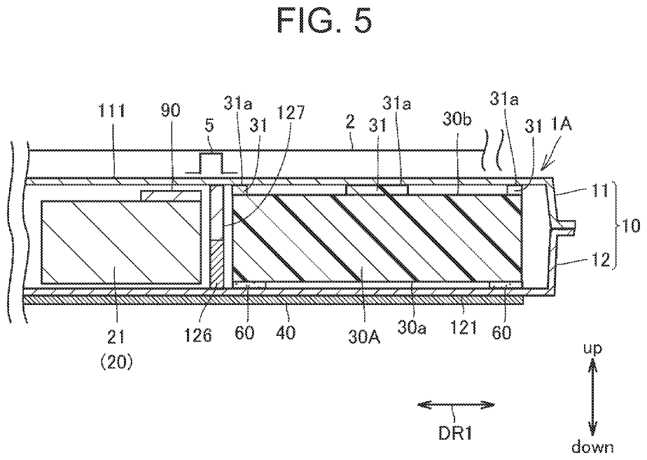

FIG. 5 is a schematic sectional view of a power storage device according to Embodiment 2. FIG. 5 shows a state in which a power storage device 1A is mounted below the floor panel 2. With reference to FIG. 5, the power storage device 1A according to Embodiment 2 will be described.

As shown in FIG. 5, when compared with the power storage device 1 according to Embodiment 1, the power storage device 1A according to Embodiment 2 is different mainly in the shape of a gap filler 30A. The other configurations are almost the same.

The gap filler 30A includes the opposite surface 30a (lower surface) and an upper surface 30b. The opposite surface 30a is located on the bottom part 121 side of the lower case 12, and the upper surface 30b is located on the ceiling part 111 side of the upper case 11.

The upper surface 30b is provided with a plurality of protrusions 31. The plurality of protrusions 31 protrudes toward the ceiling part 111 of the upper case 11. That is, the plurality of protrusions 31 protrude upward.

For example, the plurality of protrusions 31 is arranged side by side with intervals in the first direction. The plurality of protrusions 31 is provided at both ends in the first direction and at the center in the first direction of the upper surface 30b. The plurality of protrusions 31 extends in a direction intersecting the height direction. Specifically, the plurality of protrusions 31 extends in a second direction orthogonal to the first direction and the height direction. The second direction is parallel to the width direction of the vehicle in the above-mentioned mounted state.

For example, the length in the first direction of the protrusion 31 provided at the center is longer than the length of the protrusions 31 provided at both ends. In the above description, it is exemplified that three protrusions 31 are provided; however, the number of protrusions 31 is not limited. The protrusions 31 may be provided at the center of the upper surface 30b and at the periphery of the upper surface 30b. Furthermore, as will be described later, a single protrusion 31 may be provided as long as this protrusion 31 can support the ceiling part 111 of the upper case 11 and can reduce deformation of the upper case 11.

Each of the plurality of protrusions 31 has a top part 31a, and the top part 31a is located upward of the power storage module 20. More specifically, the top parts 31a are located above the high voltage part (more specifically, the power storage cells 22, the bus bar, or the connector, etc.) included in the power storage module 20.

A plurality of partition members 126 is provided within the accommodating case 10. The partition members 126 are arranged between the power storage stacks 21 adjacent to each other and also between the power storage stack 21 and the gap filler 30A. The partition members 126 are fixed to the bottom part 121. A pillar 127 is placed between each partition member 126 and the ceiling part 111. Each pillar 127 is fixed to each partition member 126.

For example, a reinforcement member 5 is disposed on the lower surface side of the floor panel 2 of the vehicle 100, and in a state in which the power storage device 1A is mounted in the vehicle 100, the pillars 127 are located below the reinforcement member 5, for example.

When an impact is input into the vehicle 100 and a force is applied downward from the reinforcement member 5, the load is downwardly applied to the upper case 11. At this time, the upper case 11 (more specifically the ceiling part 111) can be supported by the plurality of protrusions 31. Accordingly, deformation of the upper case 11 can be reduced. Furthermore, the top part 31a of each protrusion 31 is located upward of the power storage module 20; therefore, when the load is input as described above, the high voltage part included in the power storage module 20 and the upper case 11 can be prevented from coming into contact with each other. Accordingly, the power storage module 20 can be protected.

Furthermore, the plurality of protrusions 31 extends in the second direction and are arranged side by side in the first direction and thereby to reduce deformation of the upper case 11 over a wide range.

In addition, in the configuration having no protrusions 31, when the load is applied to the upper case 11 as described above, the upper case 11 is supported only by the pillars 127 fixed to the partition members 126. In this case, if the pillars 127 cannot sufficiently support the load, the pillars 127 fall down.

In the present embodiment, since deformation of the upper case 11 can be reduced by the protrusions 31 described above, it is also possible to prevent the pillars 127 from falling down. Accordingly, it is also possible to reduce the impact input from the inclined pillars 127 to the high voltage part of the power storage module 20. A protective member 90 for further reducing interference between the upper case 11 and the power storage module 20 may be disposed between the power storage module 20 and the upper case 11 (more specifically, the ceiling part 111).

As described above, the embodiments disclosed herein are illustrative and not restrictive in all respects. The scope of the present disclosure is defined by the terms of the claims, and is intended to include any modifications within the scope and meaning equivalent to the terms of the claims.

What is claimed is:

1. A power storage device comprising:
a power storage module;
an accommodating case that accommodates the power storage module;
a cooler that cools the power storage module via the accommodating case;
a gap filler being disposed in part of a gap between the power storage module and the accommodating case; and
an adhesive part that bonds the gap filler to the accommodating case, wherein
the accommodating case includes a cooling area cooled by the cooler,
the power storage module and the gap filler are arranged in the cooling area,
the gap filler includes an opposite surface that faces the cooling area, and
the adhesive part is arranged at a periphery of the opposite surface so as to seal a gap between the opposite surface and the cooling area.

2. The power storage device according to claim 1, wherein
the cooling area is arranged in a bottom part of the accommodating case, and
the bottom part is disposed to partially contact the opposite surface within an area surrounded by the adhesive part.

3. The power storage device according to claim 1, wherein
the accommodating case includes an upper case and a lower case,
the gap filler includes an upper surface and a lower surface,
the opposite surface is configured by the lower surface,
the upper surface is provided with a protrusion extending in a direction intersecting a height direction and protruding toward the upper case, and
a top part of the protrusion is located upward of the power storage module.

4. The power storage device according to claim 3, wherein
the power storage module includes a plurality of power storage stacks arranged side by side in a first direction orthogonal to the height direction,
the gap filler is arranged adjacent to the power storage module side by side in the first direction, and
a plurality of the protrusions is arranged side by side in the first direction and extends in a second direction orthogonal to the height direction and the first direction.
